(19) United States
(12) Patent Application Publication
(10) Pub. No.: US 2009/0272244 A1
(43) Pub. Date: Nov. 5, 2009

(54) Versatile saw

(76) Inventor: Claude A. Gingras, Dosquet (CA)

Correspondence Address: CLAUDE A. GINGRAS, C/o PAUL BIRON, BOX 0732, JACKMAN, ME, 04945, US

(21) Appl. No.: 12/387,689

(22) Filed: May 4, 2009

(30) Foreign Application Priority Data
May 5, 2008 (CA) 2630663

(51) Int. Cl. B26D 1/157; G05B 15/00

(52) U.S. Cl. 83/471.3; 700/275

(57) ABSTRACT

A circular saw (22) of 10-foot diameter or greater stems from a shovel stick (56) of a hydraulic shovel. The saw operates with hydraulics and linkages to adapt to all planes and positions, including taking any angular positions from 0 to 135 degrees. A control valve (61) determines the positioning of the saw thereby allowing the carving of a half-sphere in a stone wall, in concrete or in ice. The saw can be locked in the desired angle to realize a secure job. The saw is mounted on a lower rotation base (38) of 360 degrees and possesses a support device (23) mounted to the base (38) about a rotation pivot (30). Angular displacement due to the upper stationary plate (42) swivels in accordance with movements of stretching or compressing of hydraulic cylinder (49) of the shovel. The saw is used in every confined space where it is required to bring mobile equipment.

### BACKGROUND OF THE INVENTION

The invention in question in this document is claimed from U.S. Provisional deposit 61/064,443 of last Mar. 6, 2008 concerning the purpose of a circular saw installed at one end of the stick of a hydraulic shovel, to cut stone, rock, concrete, asphalt, steel, wood or other materials.

### DESCRIPTION OF THE PRIOR ART

The following inventions have caught our attention:

U.S. Pat. No. 8,494,057 “EXCAVATOR MOUNTED CONCRETE SAW” from Patrick Kelly and issued Jul. 25, 1997; showing a circular concrete saw adapted to be mounted on an articulated arm, the saw can move itself back and forth on a horizontal plane.

CA 2,055,246 “COUPE METAL” from Claude Lévesque, issued Dec. 5, 1995; shows a circular saw mounted on a four-foot base.

CA 1,329,355 “APPAREIL POUR LE SCIAGE DE CHAINES DE BÉTON OU TROTTOIRS”; device mounted on a trolley equipped with telescopic beams that support a mechanical bind on which a circular saw can slide. The saw can oscillate between two extreme positions on a vertical plane and can move on a horizontal plane.

### OBJECTIVES OF THE INVENTION

There is a great need in the construction and demolition market for a saw able to cut materials mentioned above and designed in a way to be used in all angular positions. The saw is mounted on a support device linked by a system of levers swivelling on pins to a hydraulic cylinder of a shovel stick. The levers allow the hydraulic cylinder to compress or stretch if the support of the saw changes from a horizontal position to a vertical position.

### BRIEF DESCRIPTION OF THE DRAWINGS

FIG. 1 is a view of the device as seen by the operator

FIG. 2A is a front view of the saw in vertical position

FIG. 2B is a rear view of the saw in vertical position

FIG. 3 is a view of the saw mounted on a shovel stick

FIG. 4 is a side view of the saw in a 90-degree position

FIG. 5 is a top view of rack and pinion, the saw in vertical position

FIG. 6A is a front view of the saw with polishing teeth

FIG. 6B is a face view of a tooth mounted on a shank

FIG. 6C is a face view of a tooth mounted on an angled shank

FIG. 7A is an end view of a segment on a cut saw

FIG. 7B is a top view of a segment with its screws

### DETAILED DESCRIPTION OF AN EMBODIMENT

In the following description and the related drawings, the same numbers relate to the same parts of different drawings.

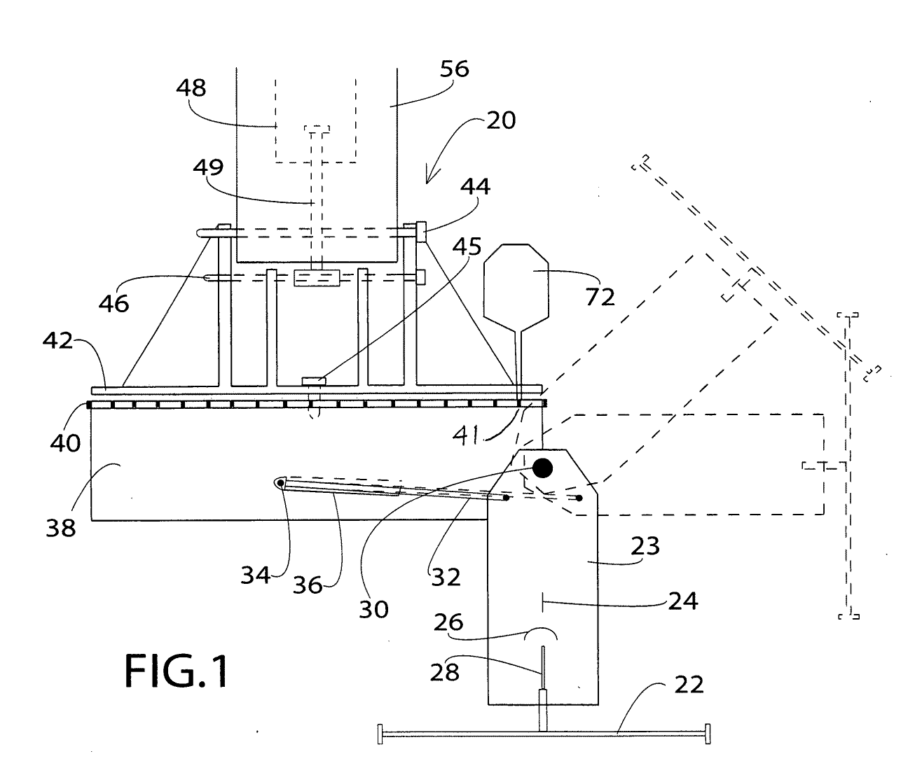

FIG. 1 shows a swing base 20 at the end of which a circular saw 22 is mounted perpendicularly to one end of a support device 23 with a stand 26 holding a rotation shaft 28 of the saw. An internal motor 24 is installed inside of the support device. The support device moves around a rotation pivot 30 with a hydraulic cylinder rod 32 allowing the saw to move angularly along a plane from 0 degree to a vertical position and even up to more than 120 degrees, the rotation pivot 30 peripheral to a lower rotation base 38 turns around a central axis 45 and driven by a ring gear 40 that provides a 360-degree rotation. The ring gear is moved by a pinion gear 41 driven by the hydraulic motor 72. An upper stationary plate 42 is linked to the shovel stick 56 by two pins 44 and 46. The saw 22 can be seen in three angular positions 0, 90 and 135 degrees. One sees a support pin 34 of the hydraulic cylinder 36 positioned on the lower rotation base 38 of the saw also the cylinder rod 49 and the shovel cylinder body 48.

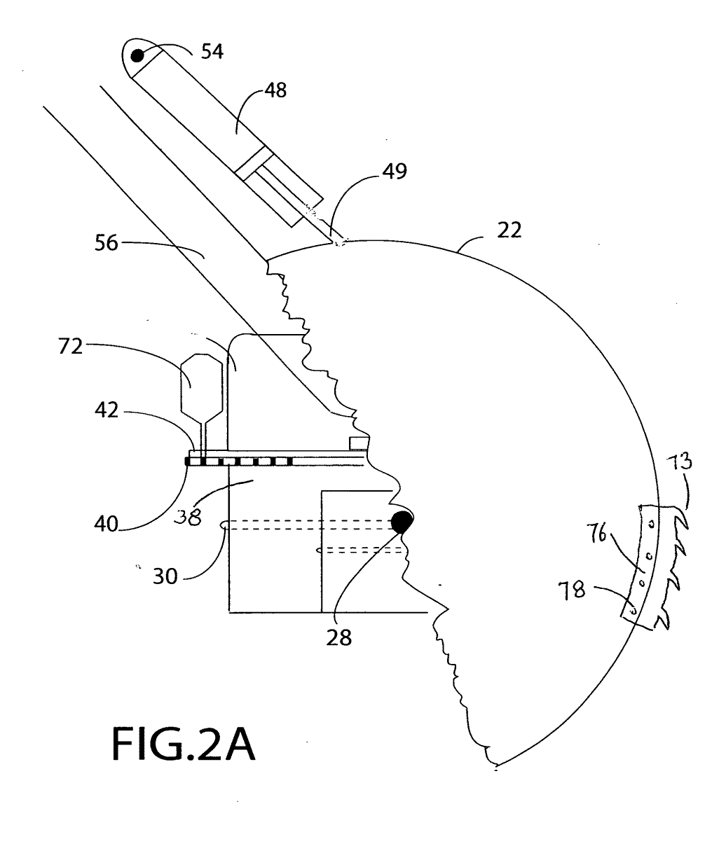

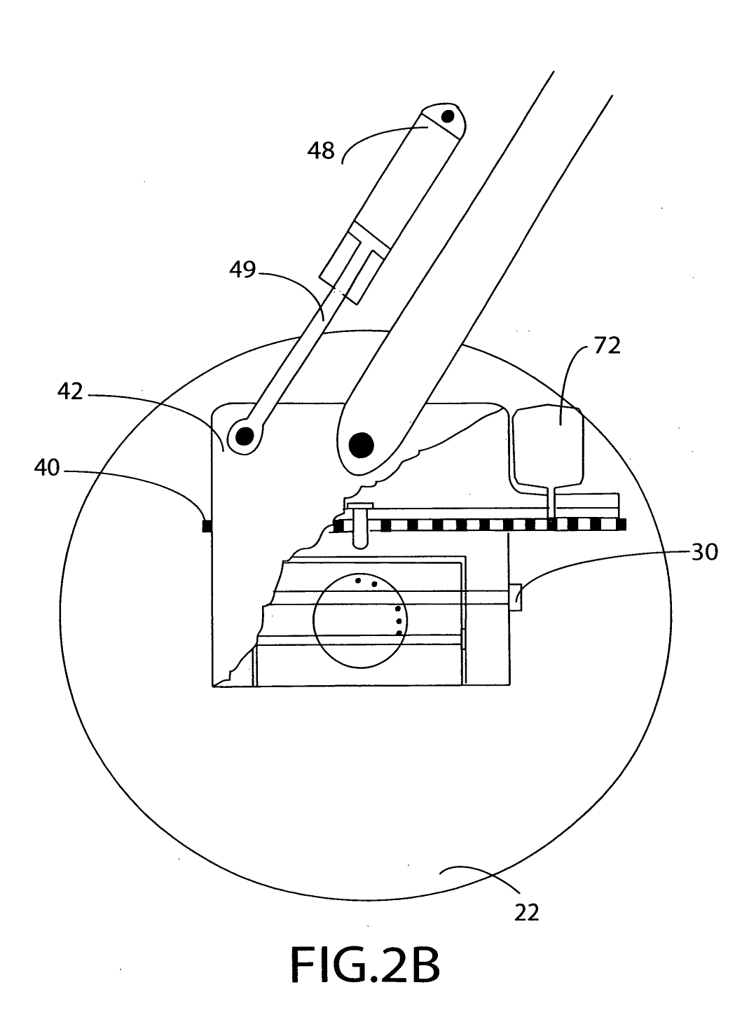

FIG. 2A shows a front view of the circular saw 22. One sees the shovel stick 56 and the cylinder rod 49. The view shows the lower rotation base 38 turning from the ring gear 40 and the upper stationary plate 42. The hydraulic motor 72 is mounted on the ring gear 40 at the exterior end. The saw is shown with a segment 76 with its cutting teeth 73 and its clipping bolts 78. The installed segment is shown bolted on for quick change.

FIG. 2B shows a rear view of the circular saw 22.

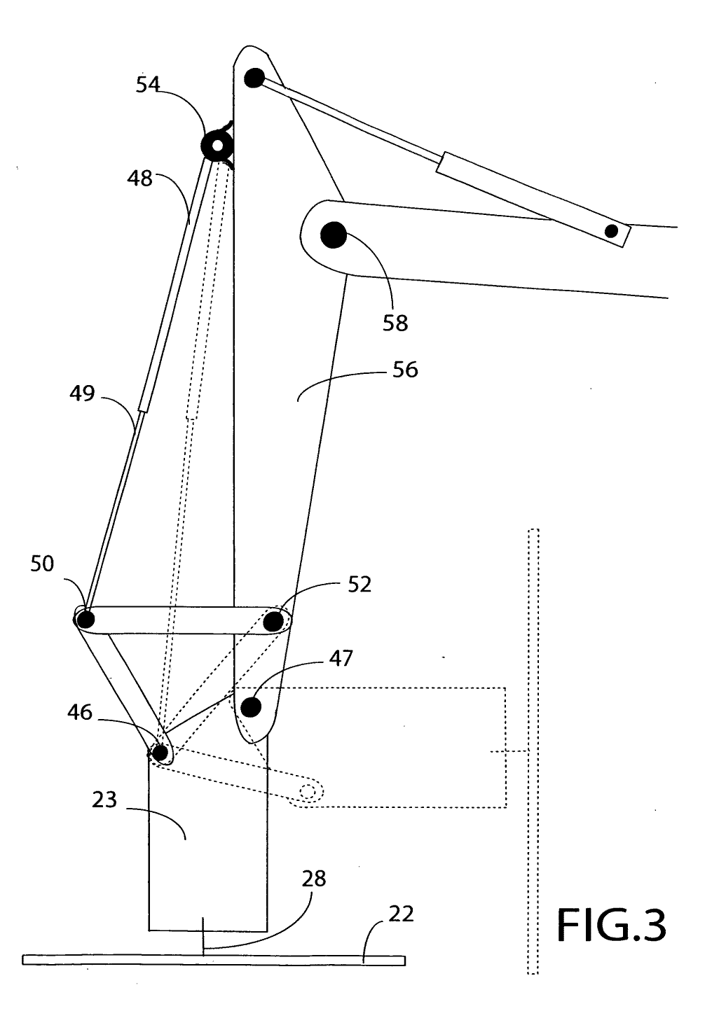

FIG. 3 shows the circular saw 22 mounted at one end of the support device 23, which is directly mounted on the stick 56. The pins 46, 47, 50 and 52 act as rotation axes around which the support device 23 moves with the saw 22. The saw is seen under two angular positions; 0 and 90 degrees.

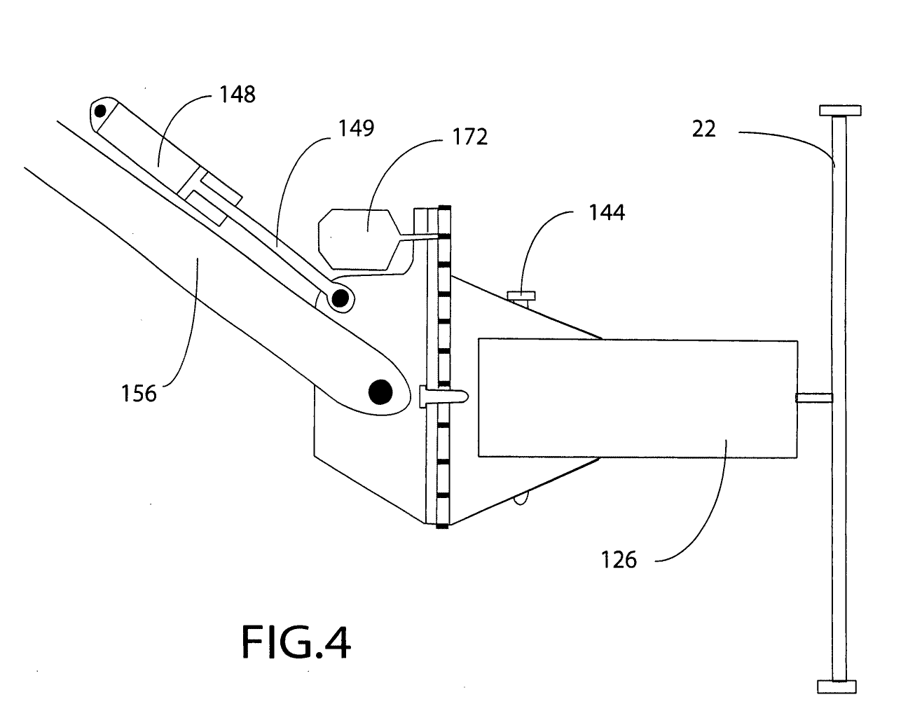

FIG. 4 shows the circular saw 22 at 90 degrees.

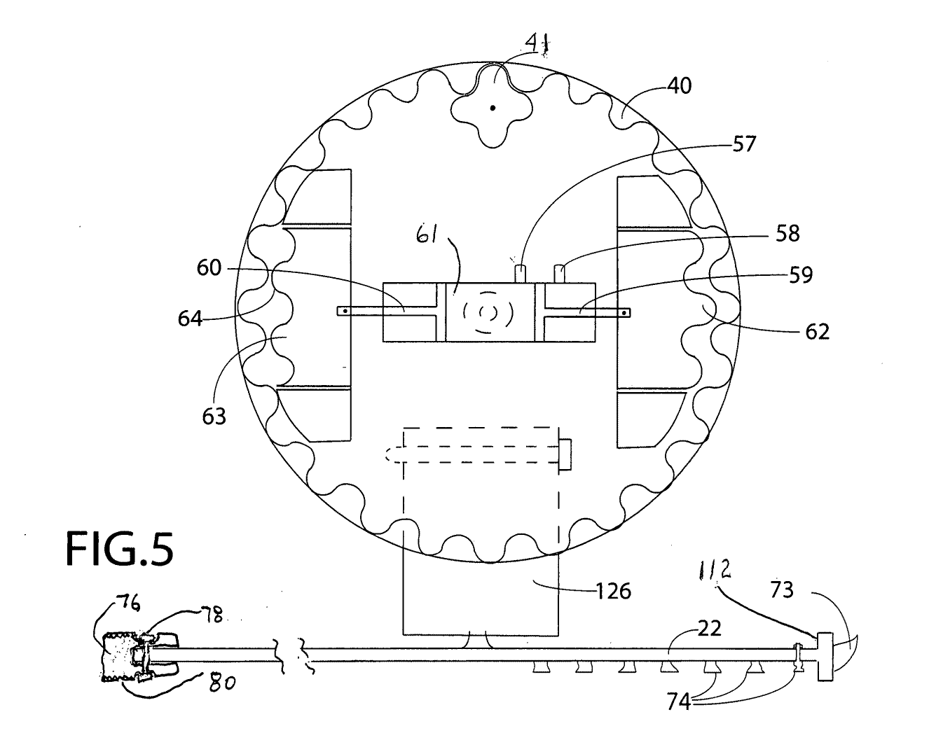

FIG. 5 shows the ring gear 40 in which 2 blocking devices, comprising a matching block 62 on the right and an offset block 63, on the left, allowing to lock the ring gear 40 in various positions including half-step. The matching block 62 is activated for interlocking by means of a right piston 59 and the offset block 63, is shifted by a half-step 64 by means of a left piston 60. The circular saw 22 is seen in vertical position. Cutting teeth 73 and polishing teeth 74 can be seen on the saw; the saw is being cut to show at the same time at either end the cutting teeth 73 and the polishing teeth 74 coupled with an abrasive face 80 of the segment 76. One sees the oil inlet pipe 57 and the oil outlet pipe 58 that activate the right piston 59.

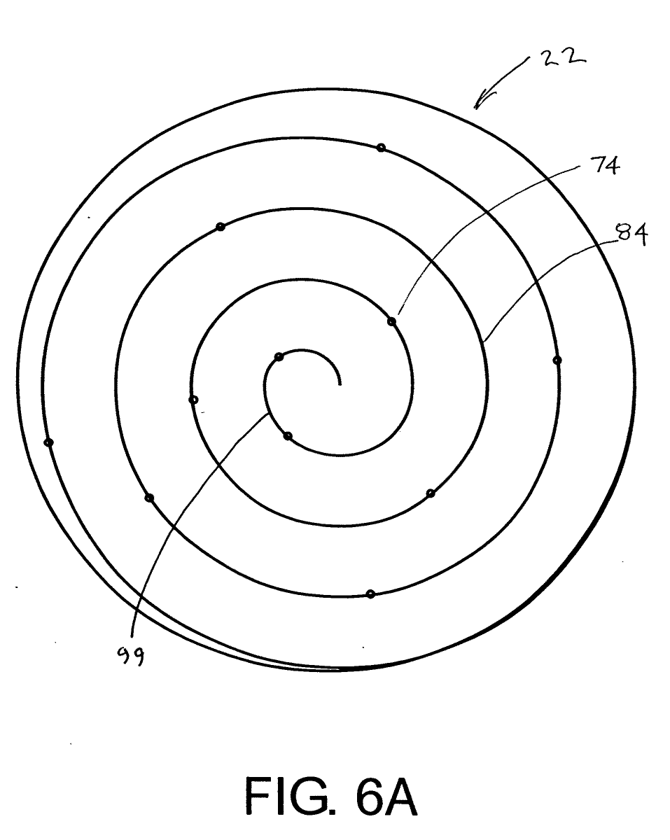

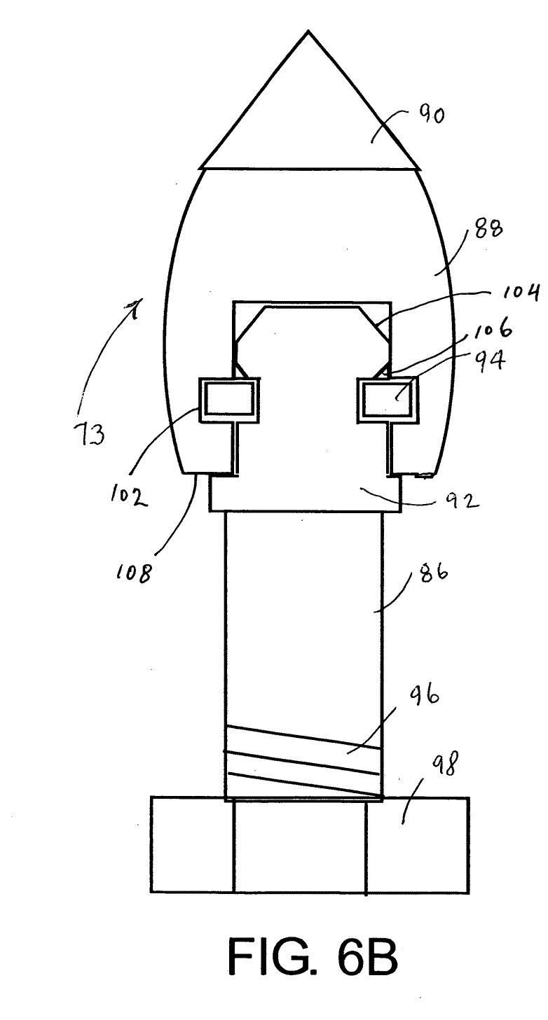

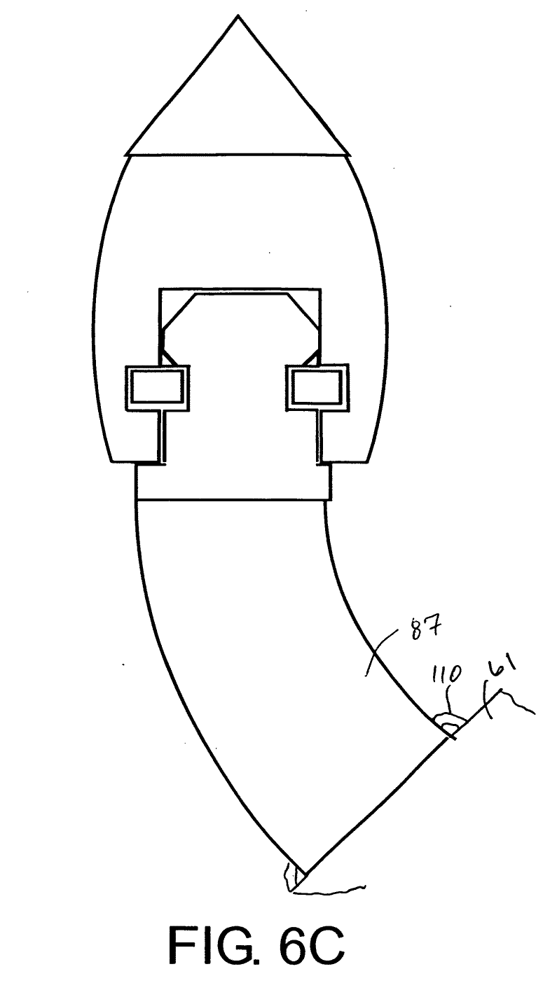

FIG. 6A shows the circular saw 22 in face view with the positioning of the polishing teeth along a spiral arrangement 84 the reason being to ascertain that the passing of the teeth is not digging a channel but its effect is spread out over each little area of a polished workpiece for a desired smoothness. Distance of teeth 99 gets progressively larger as one proceeds from the center of the saw to the peripheral edge.

FIG. 6B shows a cutting tooth made of two parts, namely a shank 86 which is straight and a sleeve tooth 88 designed to form a female over the shank 86 and which is equipped with a hard tip 90. A clipping tip 92 surmounts the shank 86 and is provided for receiving a locking element 94 which also locks the sleeve tooth. In the clipping tip 92 there is an entrance bevel of about 30 degrees to facilitate the entrance of the sleeve tooth; there is also an exit bevel 106 to facilitate the exit of the sleeve tooth with the help of a knockoff flat 108 which may be hit by a hammer. There are threads 96 to permit the fastening with a nut 98.

FIG. 6C shows an angled shank 87 which may be to the left or to the right and preferably of about 30 degrees. The angled shank is preferably welded 110 to the peripheral band 61.

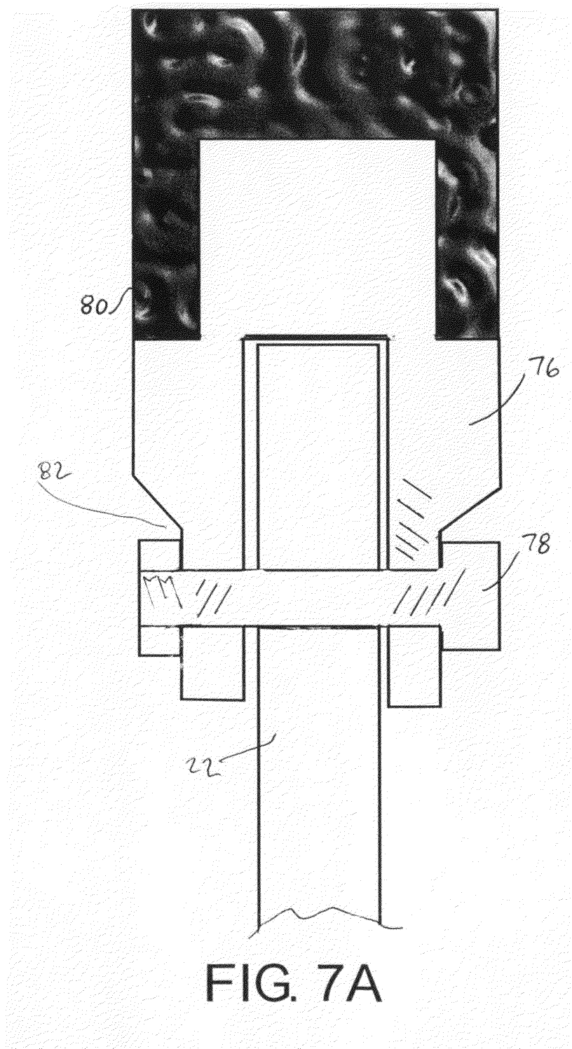

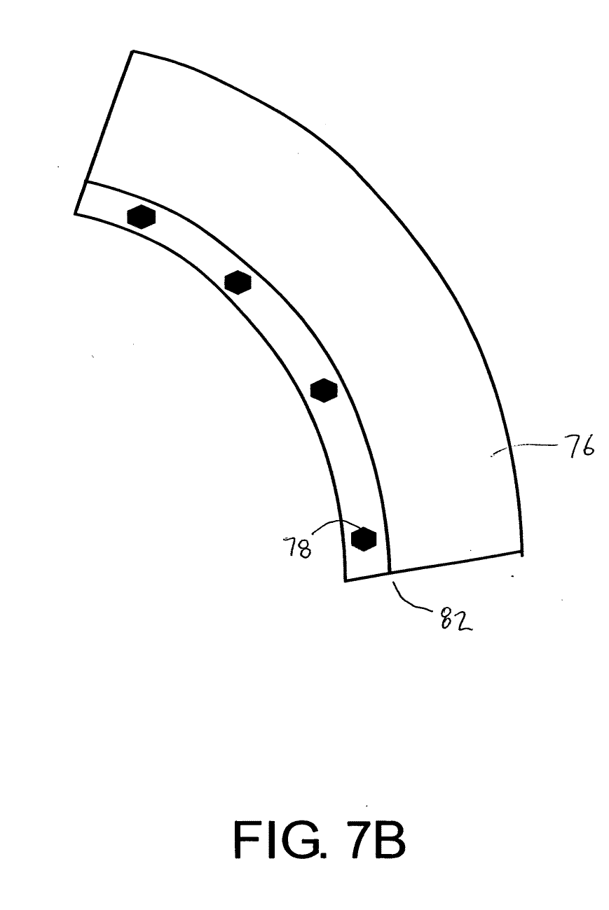

FIG. 7A shows at the edge of the circular saw 22, in a cut view the segment 76 offering a re-entrant angle 82 to permit the hiding of the clipping bolt 78 for not interfering with the polishing by the abrasive face 80.

FIG. 7B shows a typical segment 76 with four clipping bolts 78 positioned to ascertain a certain solidity as the saw may be 10 feet in diameter and subject to waiving.

### SUMMARY

A circular saw 22 mounted perpendicularly to a support device 23 comprising an internal motor 24 driving a rotation shaft 28 located at the center of the circular saw. The saw and its support device are mounted on such equipment as a hydraulic shovel which is also provided with a swing base 20 to permit a 360-degree horizontal displacement. A further angular displacement is provided by a rotation pivot 30 for the support device 23 to be mounted onto the swing base. A set of linkages permits the rotation of the support device about the pivot by means of pins 47, 46, 50 or 52 to provide an angular range to the circular saw. The circular saw is destined to cut hard materials like stone, concrete, steel and hard wood.

Angular range is ideally from 0 to 135 degrees. Pins are around the rotation pivot 30, the rotation pivot being peripheral with respect to the lower rotation base 38 turning around a central axis 45.

The circular saw is used for demolition purposes, under all angles and in every confined space where it is required to bring portable equipment. Multiple angular displacements allow the possibility to use the saw in every position. Supplemental angular displacement due to the upper stationary plate 42 swivelling in accordance with movements of stretching or compressing of the hydraulic shovel cylinder rod 49. The control valve involves a pair of blocks, namely a matching block 62 corresponding to the ring gear teeth and an offset block 63 set on the left end defining a half-step 64 destined to provide an intermediate step.

Cutting teeth 73 are located on the peripheral band 112 of the saw 22 and polishing teeth 74 are installed on the external side of the saw. The matching block (62) has coasts corresponding in shape to ring gear teeth and an offset block (63) disposed on an opposite side similarly. The half-step (64) provides finer locking positions to the movement of the ring gear.

Electronic means may program the saw in angular displacement. Other subjects and application fields of the invention in question will rise from the present description as long as the knowledge of this invention will be known.

The present description, as detailed as it is, acknowledges only the preferred applications of this invention and is only given as an illustrated issue. It is known that every inventor or experienced people in this field would be able to bring some changes without amending the range of the present invention. It is known that the embodiment mode of the present invention, described above, in reference to the drawings, has not been given as a limitation and that modifications could be brought without amending the range of the present claims.

LEGEND

| | |
|---|---|
| 20 | Swing base |
| 22 | Circular saw |
| 23 | Support device |
| 24 | Internal motor |
| 26 | Stand |
| 28 | Rotation shaft |
| 30 | Rotation pivot |
| 32 | Cylinder rod (?) |
| 36 | Hydraulic cylinder |
| 38 | Lower rotation base |
| 40 | Ring gear |
| 41 | Pinion gear |
| 42 | Upper stationary plate |
| 45 | Central axis |
| 34, 46, 47, 50, 52, 54, 58 | Pins |
| 48 | Shovel cylinder body |
| 49 | Shovel cylinder rod (?) |
| 56 | Shovel stick |
| 57 | Oil pipe inlet |
| 58 | Oil pipe outlet |
| 59 | Right piston |
| 60 | Left piston |
| 61 | Control valve |
| 62 | Matching block |
| 63 | Offset block |
| 64 | Half step |
| 72 | Hydraulic motor |
| 73 | Cutting teeth |
| 74 | Polishing teeth |
| 76 | Segment |
| 78 | Clipping bolt |
| 80 | Abrasive face |
| 82 | Reentrant angle |
| 84 | Spiral arrangement |
| 86 | Shank straight |
| 87 | Angle shank |
| 88 | Sleeve tooth |
| 90 | Hard tip |
| 92 | Clipping tip |
| 94 | Locking element |
| 96 | Threads |
| 98 | Nut |
| 99 | Distance of teeth |
| 102 | Recess |
| 104 | Entrance bevel |
| 106 | Exit bevel |
| 108 | Knock off flat 110 Weld |
| 112 | Peripheral band |

I claim:

1. A device of a circular saw (22) mounted perpendicularly to a mechanical equipment involving a support device (23) comprising an internal motor (24) driving a rotation shaft (28) engaging said circular saw, said mechanical equipment comprising means for rotating within one plane 360-degrees and pin means (47,46,50,52) to provide an angular range to said circular saw.

2. The device of claim 1 wherein said angular range is from 0 to 135 degrees and said mechanical equipment comprises a shovel stick (56) at the bottom of which there is a bottom pin (47), upwardly along said stick there is an upward pin (52), stretching from said upward position there is a first linkage directed towards a shovel cylinder rod (49) and making a junction thereupon, at said junction there is a second linkage attached to a far end of said support device at a far pin (46), a near pin of said support coinciding with said bottom pin (47), the stretching of said cylinder rod (49) engaging said far pin (46) and rotating said support device circumferentially towards a new angular position.

3. The device of claim 2 used in demolition purposes, under all angles and in every confined space where it is required to use portable equipment.

4. The device of claim 2 wherein multiple angular displacements allow the possibility to use said saw in every position.

5. The device of the claim 1 in which a supplemental angular displacement due to the brace of the upper stationary plate (42) swivelling in accordance with movements of stretching or compressing of the hydraulic cylinder of the shovel (49).

6. The device of claim 1 in which said pins are around a rotation pivot (30) of the hydraulic cylinder rod (32), said rotation pivot being peripheral with respect to a lower rotation base (38) turning around a central axis (45) and moved by rack rail means acting on a ring gear (40) to provide a 360-degree rotation.

7. The device of claim 4 involving cutting teeth (73) located on a peripheral band (112) of said saw and polishing teeth (74) installed on the external side of said saw (22).

8. The device of claim 6 in which said rack rail means comprise a matching block (62) corresponding to said ring gear teeth and an offset block (63) disposed on an opposite side of said ring gear and defining a half-step (64) destined to provide finer locking positions to the movement of said ring gear.

9. The device of claim 1 comprising electronic means to program said saw in said angular displacement.
